(19) United States
(12) Patent Application Publication
(10) Pub. No.: US 2023/0247368 A1
(43) Pub. Date: Aug. 3, 2023

(54) BUILT-IN EXPLOSION-PROOF NET VEHICLE-MOUNTED LOUDSPEAKER

(71) Applicant: Ningbo Kaishuo Lighting Technology Co., Ltd., Yuyao City, Zhejiang Province (CN)

(72) Inventor: Yanhua GAO, Yuyao City, Zhejiang Province (CN)

(73) Assignee: Ningbo Kaishuo Lighting Technology Co., Ltd., Yuyao City, Zhejiang Province (CN)

(21) Appl. No.: 16/089,783

(22) PCT Filed: Jun. 30, 2017
(86) PCT No.: PCT/CN2017/091153

§ 371 Date: Sep. 28, 2018

(30) Foreign Application Priority Data
Jun. 6, 2017 (CN) 201710418656.9

(51) Int. Cl. H04R 9/06

(52) U.S. Cl. CPC H04R 9/06; H04R 2400/11; H04R 2499/13; G08B 21/182

(57) ABSTRACT

A built-in explosion-proof net vehicle-mounted loudspeaker includes a safety protection device, a loudspeaker main body, an explosion-proof net container, a release device, and an embedded processing device. The embedded processing device is connected with the safety protection device, the loudspeaker main body, the explosion-proof net container and the release device, respectively. The explosion-proof net container is configured to accommodate an explosion-proof net. The release device is disposed at a rear end of the explosion-proof net container. When receiving a transmission control signal, the release device releases the explosion-proof net in the explosion-proof net container based on the transmission control signal. The safety protection device includes a vibration sensor connected to the loudspeaker main body for detecting a vibration value of the loudspeaker main body. When the vibration value of the loudspeaker main body is greater than or equal to a preset vibration threshold value, the embedded processing device transmits an excessive vibration signal. Through the invention, the application of the vehicle-mounted speaker can be effectively expanded.

### FIELD OF THE INVENTION

The present invention relates to a vehicle-mounted loudspeaker, and more particularly to a built-in explosion-proof net vehicle-mounted loudspeaker.

### BACKGROUND OF THE INVENTION

The bigger the loudspeaker is, the better it will be. A large-diameter woofer has better performance in the low frequency part and can be selected during the purchase. High-performance loudspeakers have the characteristics of lower transient distortion and better sound quality. In ordinary multimedia speakers, the woofers are mostly between 3 and 5 inches. High-performance loudspeakers have the characteristics of lower transient distortion and better sound quality.

The most common loudspeaker is an electric paper cone loudspeaker. An electric cone-shaped loudspeaker is often referred to as a paper cone loudspeaker. Although the diaphragm was dominated by paper cones in 2014, many polymer material diaphragms and metal diaphragms are developed on the market. A conical paper cone loudspeaker is mainly composed of a magnetic circuit system (a permanent magnet, a core post, a guide magnetic plate), a vibration system (a paper cone, a voice coil) and a support auxiliary system (a centering piece, a cone frame, a cushion), etc.

A vehicle-mounted loudspeaker is often applied to a police car. The police officers hope that the vehicle-mounted loudspeaker can help them to carry out policing operations, such as identifying wanted criminals, locating wanted criminals and even capturing wanted criminals. However, the conventional vehicle-mounted loudspeaker only has the functions of alarm and warning.

### SUMMARY OF THE INVENTION

In order to solve the above problems, the present invention provides a built-in explosion-proof net vehicle-mounted loudspeaker, integrating an image recognition device, an explosion-proof net container, a release device and a security protection device for recognizing a human sub-image from a captured image, and determining whether the human sub-image includes the facial features of a wanted criminal, and determining a transmission direction based on a relative position of the human sub-image in the foreground image when the facial features are included, and determining a transmission intensity based on a depth of field of the human sub-image in the foreground image. The embedded processing device packs the transmission direction and the transmission intensity to generate a transmission control signal, such that the release device releases an explosion-proof net in accordance with the transmission control signal to capture the wanted criminal.

According to one aspect of the present invention, a built-in explosion-proof net vehicle-mounted loudspeaker is provided. The system comprises a safety protection device, a loudspeaker main body, an explosion-proof net container, a release device, and an embedded processing device. The embedded processing device is connected with the safety protection device, the loudspeaker main body, the explosion-proof net container and the release device, respectively. The explosion-proof net container is configured to accommodate an explosion-proof net. The release device is disposed at a rear end of the explosion-proof net container. When receiving a transmission control signal, the release device releases the explosion-proof net in the explosion-proof net container based on the transmission control signal.

Wherein, the safety protection device includes a vibration sensor connected to the loudspeaker main body for detecting a vibration value of the loudspeaker main body. When the vibration value of the loudspeaker main body is greater than or equal to a preset vibration threshold value, the embedded processing device transmits an excessive vibration signal.

Preferably, the built-in explosion-proof net vehicle-mounted loudspeaker further comprises a loudspeaker bracket disposed on a top of a vehicle body of a vehicle for fixing the loudspeaker main body to the top of the vehicle body of the vehicle.

Preferably, in the built-in explosion-proof net vehicle-mounted loudspeaker, the safety protection device, the explosion-proof net container and the release device are all located on the loudspeaker bracket. Wherein, the embedded processing device is disposed in a front dashboard of the vehicle.

Preferably, in the built-in explosion-proof net vehicle-mounted loudspeaker, when the explosion-proof net container has the explosion-proof net, an explosion-proof net presence signal is transmitted. When the explosion-proof net container doesn't have the explosion-proof net, an explosion-proof net absence signal is transmitted.

Preferably, the built-in explosion-proof net vehicle-mounted loudspeaker further comprises:

a buzzer disposed on the loudspeaker bracket and connected to the embedded processing device for emitting an alarm sound when receiving the excessive vibration signal;

a high-definition camera embedded in the loudspeaker bracket for performing video data acquisition around the vehicle to obtain a real-time video streaming, the real-time video streaming being composed of temporally consecutive multi-frame images;

an edge enhancement device connected to the high-definition camera for performing edge enhancement on a new frame image to obtain a new enhanced image of the real-time video streaming each time the new frame image of the real-time video streaming is received;

a wavelet filtering device connected to the edge enhancement device for performing a Daubechies wavelet filtering process on the new enhanced image of the real-time video streaming to obtain a new filtered image of the real-time video streaming each time the new enhanced image of the real-time video streaming is received, wherein the Daubechies wavelet filtering process performed by the wavelet filtering device comprises performing a 3-level decomposition on the new enhanced image of the real-time video streaming by using a Daubechies wavelet base of length 4 and then performing wavelet reconstruction to obtain the new filtered image of the real-time video streaming;

a background segmentation device connected to the wavelet filtering device for performing the following process on each pixel in the new filtered image as a target pixel each time the new filtered image of the real-time video streaming is received: determining whether a pixel value of the target pixel matches a pixel value of a pixel corresponding in position to a previous background image, if matched, the target pixel being used as a background point, if not matched, the target pixel being used as a non-background point, in all previous images of the real-time video streaming, counting the probability that the pixel corresponding in position to the target pixel is determined as the background point, wherein when the probability is greater than or equal to a preset probability threshold, the pixel value that is determined as the background point in the corresponding position of the target pixel in the previous images is used to update the pixel value corresponding in position to the target pixel in the previous background image; wherein the background segmentation device outputs an updated background image after performing the above process on the last pixel in the new filtered image;

a target recognition device connected to the background segmentation device for subtracting the new filtered image of the real-time video streaming from the updated background image of the new filtered image of the real-time video streaming by the background segmentation device to get a foreground image, and performing matching based on preset human body color histogram features on a target in the foreground image to determine a human body target in the foreground image, and outputting a human sub-image corresponding to the human body target and segmented from the foreground image;

wherein the embedded processing device is further connected to the target recognition device for determining whether the human sub-image includes all facial features of a wanted criminal, and determining a transmission direction based on a relative position of the human sub-image in the foreground image when the facial features are included, and determining a transmission intensity based on a depth of field of the human sub-image in the foreground image, wherein the embedded processing device packs the transmission direction and the transmission intensity to generate the transmission control signal;

wherein the embedded processing device transmits the transmission control signal to the release device for controlling the release device to release the explosion-proof net in the explosion-proof net container based on the transmission control signal.

Preferably, in the built-in explosion-proof net vehicle-mounted loudspeaker, releasing the explosion-proof net in the explosion-proof net container based on the transmission control signal by the release device includes parsing the transmission control signal to obtain the transmission direction and the transmission intensity.

Preferably, in the built-in explosion-proof net vehicle-mounted loudspeaker, releasing the explosion-proof net in the explosion-proof net container based on the transmission control signal by the release device includes releasing the explosion-proof net in the explosion-proof net container based on the transmission direction and the transmission intensity.

Preferably, the built-in explosion-proof net vehicle-mounted loudspeaker further comprises a 3G communication interface connected to the embedded processing device for downloading the preset human body color histogram features and the facial features of the wanted criminal from a server of a remote police control center. Wherein, the 3G communication interface is disposed on the top of the vehicle body of the vehicle.

### BRIEF DESCRIPTION OF THE DRAWINGS

The embodiments of the present invention will be described below with reference to the accompanying drawings, in which:

FIG. 1 is a structural block diagram of a built-in explosion-proof net vehicle-mounted loudspeaker according to an embodiment of the present invention.

List of reference numbers: 1 safety protection device; 2 loudspeaker main body; 3 explosion-proof net container; 4 release device; 5 embedded processing device

### DETAILED DESCRIPTION OF THE PREFERRED EMBODIMENTS

An embodiment of the built-in explosion-proof net vehicle-mounted loudspeaker of the present invention will be described in detail below with reference to the accompanying drawings.

A loudspeaker, also known as a speaker, is a transducing device that converts an electrical signal into an acoustic signal. The performance of the speaker has a great influence on the sound quality. The speaker is one of the weakest components in audio equipment, and it is one of the most important parts for sound effects. There are many different types of speakers, and the prices vary greatly. Through electromagnetic, piezoelectric or electrostatic effects, audio power enables the paper cone or diaphragm to vibrate and resonate with the surrounding air to produce sound.

Low-grade plastic speakers have a thin body that cannot overcome resonance, and the sound quality is poor. (Some plastic speakers are better than inferior wooden speakers.) Wooden speakers reduce the sound noise caused by the resonance of the box, so the sound quality is generally better than that of plastic speakers.

In general, multimedia speakers are dual-unit two-way speakers, with one smaller speaker as a tweeter and the other larger speaker as a woofer.

Conventional police car loudspeakers are often used to deter criminals, preventing or avoiding the occurrence of criminal acts. There is very little participation in police work. In order to overcome the above deficiencies, the present invention discloses a built-in explosion-proof net vehicle-mounted loudspeaker, which can orient the explosion-proof net to capture the wanted criminals, thereby solving the above technical problems.

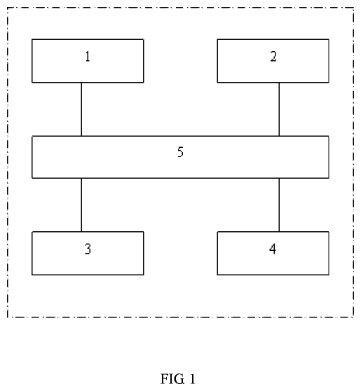

FIG. 1 is a structural block diagram of a built-in explosion-proof net vehicle-mounted loudspeaker according to an embodiment of the present invention. The system includes a safety protection device, a loudspeaker main body, an explosion-proof net container, a release device, and an embedded processing device. The embedded processing device is connected with the safety protection device, the loudspeaker main body, the explosion-proof net container and the release device, respectively. The explosion-proof net container is configured to accommodate an explosion-proof net. The release device is disposed at a rear end of the explosion-proof net container. When receiving a transmission control signal, the release device releases the explosion-proof net in the explosion-proof net container based on the transmission control signal.

Wherein, the safety protection device includes a vibration sensor connected to the loudspeaker main body for detecting a vibration value of the loudspeaker main body. When the vibration value of the loudspeaker main body is greater than or equal to a preset vibration threshold value, the embedded processing device transmits an excessive vibration signal.

Next, the specific structure of the built-in explosion-proof net vehicle-mounted loudspeaker of the present invention will be further described.

The vehicle-mounted loudspeaker further includes a loudspeaker bracket disposed on a top of a vehicle body of a vehicle for fixing the loudspeaker main body to the top of the vehicle body of the vehicle.

In the vehicle-mounted loudspeaker, the safety protection device, the explosion-proof net container and the release device are all located on the loudspeaker bracket. Wherein, the embedded processing device is disposed in a front dashboard of the vehicle.

In the vehicle-mounted loudspeaker, when the explosion-proof net container has the explosion-proof net, an explosion-proof net presence signal is transmitted. When the explosion-proof net container doesn't have the explosion-proof net, an explosion-proof net absence signal is transmitted.

The vehicle-mounted loudspeaker further includes a buzzer disposed on the loudspeaker bracket and connected to the embedded processing device for emitting an alarm sound when receiving the excessive vibration signal.

A high-definition camera is embedded in the loudspeaker bracket for performing video data acquisition around the vehicle to obtain a real-time video streaming. The real-time video streaming is composed of temporally consecutive multi-frame images.

An edge enhancement device is connected to the high definition camera for performing edge enhancement on a new frame image to obtain a new enhanced image of the real-time video streaming each time the new frame image of the real-time video streaming is received.

A wavelet filtering device is connected to the edge enhancement device for performing a Daubechies wavelet filtering process on the new enhanced image of the real-time video streaming to obtain a new filtered image of the real-time video streaming each time the new enhanced image of the real-time video streaming is received. Wherein, the Daubechies wavelet filtering process performed by the wavelet filtering device comprises: performing a 3-level decomposition on the new enhanced image of the real-time video streaming by using a Daubechies wavelet base of length 4, and then performing wavelet reconstruction to obtain the new filtered image of the real-time video streaming.

A background segmentation device is connected to the wavelet filtering device for performing the following process on each pixel in the new filtered image as a target pixel each time the new filtered image of the real-time video streaming is received: determining whether the pixel value of the target pixel matches the pixel value of the pixel corresponding in position to the previous background image, if matched, the target pixel being used as the background point, if not matched, the target pixel being used as the non-background point, in all the previous images of the real-time video streaming, counting the probability that the pixel corresponding in position to the target pixel is determined as the background point. When the probability is greater than or equal to a preset probability threshold, the pixel value that is determined as the background point in the corresponding position of the target pixel in the previous images is used to update the pixel value corresponding in position to the target pixel in the previous background image. The background segmentation device outputs an updated background image after performing the above processing on the last pixel in the new filtered image.

A target recognition device is connected to the background segmentation device for subtracting the new filtered image of the real-time video streaming from the updated background image of the new filtered image of the real-time video streaming by the background segmentation device to get a foreground image, and performing matching based on preset human body color histogram features on the target in the foreground image to determine a human body target in the foreground image, and outputting a human sub-image corresponding to the human body target and segmented from the foreground image.

Wherein, the embedded processing device is further connected to the target recognition device for determining whether the human sub-image includes all the facial features of the wanted criminal, and determining a transmission direction based on a relative position of the human sub-image in the foreground image when the facial features are included, and determining a transmission intensity based on a depth of field of the human sub-image in the foreground image. The embedded processing device packs the transmission direction and the transmission intensity to generate the transmission control signal. The embedded processing device transmits the transmission control signal to the release device for controlling the release device to release the explosion-proof net in the explosion-proof net container based on the transmission control signal.

In the vehicle-mounted loudspeaker, releasing the explosion-proof net in the explosion-proof net container based on the transmission control signal by the release device includes: parsing the transmission control signal to obtain the transmission direction and the transmission intensity.

In the vehicle-mounted loudspeaker, releasing the explosion-proof net in the explosion-proof net container based on the transmission control signal by the release device includes: releasing the explosion-proof net in the explosion-proof net container based on the transmission direction and the transmission intensity.

The vehicle-mounted loudspeaker further includes a 3G communication interface connected to the embedded processing device for downloading the preset human body color histogram features and the facial features of the wanted criminal from a server of a remote police control center. Wherein, the 3G communication interface is disposed on the top of the vehicle body of the vehicle.

In addition, the 3G communication interface can be replaced with a time division duplex communication interface. Time division duplex is a duplex method of a communication system for separating receiving and transmitting channels in a mobile communication system. Mobile communication is currently developing in the third generation. China submitted the draft of the third generation mobile communication standard (TD-SCDMA) in June 1997. Its features such as TDD mode and smart antenna technology are highly evaluated and become one of the three main candidate criteria. In the first and second generation mobile communication systems, FDD mode dominated the world, and TDD mode did not attract attention. However, due to the needs of new services and the development of new technologies as well as many advantages of TDD model, TDD model is increasingly valued.

The working principle of the time division duplex is as follows: TDD is a duplex mode of a communication system, used to separate the receiving and transmitting channels (or uplink and downlink) in a mobile communication system. In the mobile communication system of TDD mode, the receiving and transmitting are performed in the same frequency channel, that is, the different time slots of the carrier, with the guaranteed time to separate the receiving and transmitting channels. In the mobile communication system of FDD mode, the receiving and transmitting are performed in two separated symmetrical frequency channels, with the guaranteed frequency band to separate the receiving and transmitting channels.

The characteristics and communication efficiencies of the mobile communication systems using different duplex modes are different from each other. In the mobile communication system of TDD mode, the uplink and downlink channels use the same frequency and thus have the reciprocity of the uplink and downlink channels, which brings many advantages to the mobile communication system of TDD mode.

In TDD mode, the transmission of information in the uplink and downlink can be performed in the same carrier frequency, that is, the transmission of information in the uplink and the transmission of information in the downlink are implemented by time division on the same carrier.

The built-in explosion-proof net vehicle-mounted loudspeaker of the present invention is to solve the technical problem of the conventional vehicle-mounted loudspeaker. By modifying the conventional vehicle-mounted loudspeaker, the vehicle-mounted loudspeaker of the present invention is integrated with a customized image recognition device and an explosion-proof net release device to perform image recognition and positioning on nearby wanted criminals. Based on the result of the image recognition and positioning, the explosion-proof net is released to capture the wanted criminal, thereby relieving the police work greatly.

It is to be understood that the above-described embodiments are not intended to limit the present invention, although particular embodiments of the present invention have been described in detail for purposes of illustration. For those skilled in the art, many possible variations, modifications and equivalent embodiments may be made to the technical solutions of the present, without departing from the scope of the present invention. Therefore, any simple modifications, equivalent changes, and enhancements of the above embodiments may be made without departing from the spirit and scope of the invention.

1-8. (canceled)

9. A built-in explosion-proof net vehicle-mounted loudspeaker, comprising a safety protection device, a loudspeaker main body, an explosion-proof net container, a release device and an embedded processing device, the embedded processing device being connected with the safety protection device, the loudspeaker main body, the explosion-proof net container and the release device respectively, the explosion-proof net container being configured to accommodate an explosion-proof net, the release device being disposed at a rear end of the explosion-proof net container, wherein when receiving a transmission control signal, the release device releases the explosion-proof net in the explosion-proof net container based on the transmission control signal;
wherein the safety protection device includes a vibration sensor connected to the loudspeaker main body for detecting a vibration value of the loudspeaker main body, when the vibration value of the loudspeaker main body is greater than or equal to a preset vibration threshold value, the embedded processing device transmits an excessive vibration signal;
further comprising a loudspeaker bracket disposed on a top of a vehicle body of a vehicle for fixing the loudspeaker main body to the top of the vehicle body of the vehicle;
wherein the safety protection device, the explosion-proof net container and the release device are all located on the loudspeaker bracket; wherein the embedded processing device is disposed in a front dashboard of the vehicle;
wherein when the explosion-proof net container has the explosion-proof net, an explosion-proof net presence signal is transmitted, when the explosion-proof net container doesn't have the explosion-proof net, an explosion-proof net absence signal is transmitted;
further comprising:
a buzzer disposed on the loudspeaker bracket and connected to the embedded processing device for emitting an alarm sound when receiving the excessive vibration signal;
a high-definition camera embedded in the loudspeaker bracket for performing video data acquisition around the vehicle to obtain a real-time video streaming, the real-time video streaming being composed of temporally consecutive multi-frame images;
an edge enhancement device connected to the high-definition camera for performing edge enhancement on a new frame image to obtain a new enhanced image of the real-time video streaming each time the new frame image of the real-time video streaming is received;
a wavelet filtering device connected to the edge enhancement device for performing a Daubechies wavelet filtering process on the new enhanced image of the real-time video streaming to obtain a new filtered image of the real-time video streaming each time the new enhanced image of the real-time video streaming is received, wherein the Daubechies wavelet filtering process performed by the wavelet filtering device comprises performing a 3-level decomposition on the new enhanced image of the real-time video streaming by using a Daubechies wavelet base of length 4 and then performing wavelet reconstruction to obtain the new filtered image of the real-time video streaming;
a background segmentation device connected to the wavelet filtering device for performing the following process on each pixel in the new filtered image as a target pixel each time the new filtered image of the real-time video streaming is received: determining whether a pixel value of the target pixel matches a pixel value of a pixel corresponding in position to a previous background image, if matched, the target pixel being used as a background point, if not matched, the target pixel being used as a non-background point, in all previous images of the real-time video streaming, counting the probability that the pixel corresponding in position to the target pixel is determined as the background point, wherein when the probability is greater than or equal to a preset probability threshold, the pixel value that is determined as the background point in the corresponding position of the target pixel in the previous images is used to update the pixel value corresponding in position to the target pixel in the previous background image; wherein the background segmentation device outputs an updated background image after performing the above process on the last pixel in the new filtered image;
a target recognition device connected to the background segmentation device for subtracting the new filtered image of the real-time video streaming from the updated background image of the new filtered image of the real-time video streaming by the background segmentation device to get a foreground image, and performing matching based on preset human body color histogram features on a target in the foreground image to determine a human body target in the foreground image, and outputting a human sub-image corresponding to the human body target and segmented from the foreground image;
wherein the embedded processing device is further connected to the target recognition device for determining whether the human sub-image includes all facial features of a wanted criminal, and determining a transmission direction based on a relative position of the human sub-image in the foreground image when the facial features are included, and determining a transmission intensity based on a depth of field of the human sub-image in the foreground image, wherein the embedded processing device packs the transmission direction and the transmission intensity to generate the transmission control signal;
wherein the embedded processing device transmits the transmission control signal to the release device for controlling the release device to release the explosion-proof net in the explosion-proof net container based on the transmission control signal.

10. The built-in explosion-proof net vehicle-mounted loudspeaker as claimed in claim 9, wherein releasing the explosion-proof net in the explosion-proof net container based on the transmission control signal by the release device includes parsing the transmission control signal to obtain the transmission direction and the transmission intensity.

11. The built-in explosion-proof net vehicle-mounted loudspeaker as claimed in claim 10, wherein releasing the explosion-proof net in the explosion-proof net container based on the transmission control signal by the release device includes releasing the explosion-proof net in the explosion-proof net container based on the transmission direction and the transmission intensity.

12. The built-in explosion-proof net vehicle-mounted loudspeaker as claimed in claim 11, further comprises a 3G communication interface connected to the embedded processing device for downloading the preset human body color histogram features and the facial features of the wanted criminal from a server of a remote police control center, wherein the 3G communication interface is disposed on the top of the vehicle body of the vehicle.
